(19) United States
(12) Patent Application Publication
(10) Pub. No.: US 2022/0006783 A1
(43) Pub. Date: Jan. 6, 2022

(54) PRIVACY PRESERVING COOPERATIVE FIREWALL RULE OPTIMIZER

(71) Applicant: Accenture Global Solutions Limited, Dublin (IE)

(72) Inventors: Amin Hassanzadeh, Arlington, VA (US); Benjamin Glen McCarty, Washington, DC (US)

(21) Appl. No.: 16/920,369

(22) Filed: Jul. 2, 2020

(51) Int. Cl. H04L 29/06; G06N 20/00

(52) U.S. Cl. CPC H04L 63/0263; G06N 20/00

(57) ABSTRACT

Embodiments of the present disclosure provide centralized and coordinated learning techniques for configuration and optimization of firewall rules. Features of an address space (e.g., an IPv4 address space) is obtained and analyzed. A raw model comprising parameters for labeling firewall rules associated with the address space may be generated based on the features and distributed to a plurality of organizations. The organizations may use a subset of their local firewall rules to train the model and each organization may provide feedback to a centralized firewall analysis device based on the training. The firewall analysis device may generate an updated model based on the feedback and distribute the updated model to the organizations. The updated model may include parameters that result in the updated model applying different labels to firewall rules as compared to the raw model. The models may also be utilized optimize and consolidate firewall rules.

### TECHNICAL FIELD

The present application relates to network security and more specifically to federated learning techniques for configuring firewall rules while keeping firewall rules for each federated entity secret.

### BACKGROUND

Firewalls play an important role in protecting the security of networks and the users that are supported by the networks. For example, firewalls may be configured to prevent users from initiating connections between the user's computing device (e.g., an employee computer, etc.) and external Internet domains and resources, such as a known botnet node or other type of malicious or otherwise undesirable Internet node (e.g., if an employer does not want its employees from accessing certain websites from their work device or for other purposes). To configure a firewall, an administrator must create rules, known as firewall rules, that specify whether a computing device associated with the firewall may establish a connection to an Internet resource, which may be an incoming connection (e.g., a connection initiated from the computing device) or an outgoing connection (e.g., a connection initiated external to the domain served by the firewall). To illustrate, a firewall rule may specify that a connection between a source Internet protocol (IP) address and a destination IP address should be permitted or denied. If the connection is permitted, a user may be able to access an Internet resources associated with the permitted IP address from the user's computing device, such as a workplace computing device. However, if the connection is to be denied, the user may not be able to access the Internet resources associated with the IP address from the user's computing device.

While firewalls and firewall rules provide significant control and security capabilities for enforcing an entity's network policies, presently available techniques for configuring firewalls suffer from several drawbacks. As an example, present firewalls are limited to approximately 65,000 firewall rules and once this limit is reached the most firewalls start to become slow or crash. Many entities want to block more than 60,000 different IP addresses at a time, which would be problematic since doing so may require those entities to create a set of firewall rules that exceeds the 65,000 rule limit, which would degrade the performance of the firewall (e.g., cause packet loss, etc.) and potentially cause the firewall to crash. Additionally, it is noted that the approximately 65,000 rule limit is representative of firewall appliances that are very sophisticated and less sophisticated firewall appliances would have much smaller rule thresholds with respect to the number of firewall rules that may be specified (e.g., 16,000 rules or less) before performance begins to degrade.

To address challenges imposed by the number of firewall rules that may be created without degrading performance of the firewall, some entities have utilized super-netting. Super-netting groups IP addresses into blocks, which may enable a single firewall rule to be configured to control access permissions for a large amount of IP addresses, such as to block or deny access to the IP addresses of a specified super-net. However, determining which sub-nets or networks to block can be a very difficult task and if done incorrectly may prevent some users from accessing services they should actually be allowed to access. Due to the complexities associated with configuration of firewall rules based on super-nets and the potential for access to some Internet resources being unintentionally blocked, many organizations just allow all IP addresses, which is a less than optimal solution to the problem and could expose users to potentially malicious Internet resources and domains.

One way the challenges of configuring firewall rules (including configurations utilizing super-netting techniques) could be avoided or reduced is for different entities to share their firewall rules. However, this solution is also problematic because a malicious actor may be able to use the firewalls rules to circumvent the network policies for which the firewall rules were intended, such as by spoofing an IP address that is allowed by the firewall rules. Thus, configuration of firewall rules remains a challenging task both in terms of performance of the firewall (e.g., establishing a set of firewall rules that enable or deny connections to a sufficient number of IP addresses but does not crash the firewall) and maintaining the security of the firewall rules to prevent malicious actors from exploiting the rules in a harmful way.

An additional challenge associated with configuration of firewall rules is that IP addresses may be periodically reassigned. For example, an IP address may be associated with a first entity and at a later point in time that entity may no longer use that IP address and it may be assigned to a different entity. Accounting for such IP address changes requires that firewall rules be updated frequently (e.g., so that a malicious actor cannot simply change IP addresses to avoid firewall protections).

### SUMMARY

The present application discloses systems, methods, and computer-readable storage media for utilizing distributed learning techniques to configure and optimize firewalls. The techniques disclosed herein utilize machine learning techniques in a cooperative environment that allows training of models to be performed locally by different organizations using local firewall rules. The training of the models may generate feedback that is used to generate updated models that may provide a more accurate labeling of firewall rules (e.g., labelling firewall rules with actions such as allow or deny). For example, a first instance of the model may be trained using firewall rules of many different organizations, each organization performing the training locally and without sharing their firewall rules. The feedback from that training may be used to generate an updated model that more accurately labels firewall rules (e.g., applies deny labels or actions to firewall rules that should deny connections and allow labels or actions to firewall rules that should allow connections). Training the model(s) separately using input data sets derived from the firewall rules of different organizations enables the models to rapidly learn how to correctly apply labels to firewall rules.

In addition to training the models, the organizations may use the models to create or verify firewall rules presently used by their respective firewalls. For example, an organization may provide all or a portion of their firewall rules as inputs to the model and the model may output a set of labels for those firewall rules. Firewall rules configured with labels determined by the models of embodiments may be tested to verify they will not have a negative impact on the organization's network (e.g., block desired traffic, allow undesired traffic, overload the firewall, etc.) and once verified, deployed to the live firewall of the organization. Additionally, the models may be periodically updated based on changes to features of the address space within the scope of the model (e.g., an IPv4 or IPv6 address space), thereby allowing changes in the features to be taken into account by the model and the labels that the model provides as output.

The foregoing has outlined rather broadly the features and technical advantages of the present invention in order that the detailed description of the invention that follows may be better understood. Additional features and advantages of the invention will be described hereinafter which form the subject of the claims of the invention. It should be appreciated by those skilled in the art that the conception and specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims. The novel features which are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

### BRIEF DESCRIPTION OF THE DRAWINGS

For a more complete understanding of the disclosed methods and apparatuses, reference should be made to the implementations illustrated in greater detail in the accompanying drawings, wherein:

FIG. 1 is block diagram illustrating aspects of a system for configuring firewall rules using federated learning techniques while keeping firewall rules for each federated entity secret in accordance with embodiments of the present disclosure;

FIG. 2 is block diagram illustrating additional aspects of a system for configuring firewall rules using federated learning techniques while keeping firewall rules for each federated entity secret in accordance with embodiments of the present disclosure;

FIG. 3 is block diagram illustrating additional aspects of a system for configuring firewall rules using federated learning techniques while keeping firewall rules for each federated entity secret in accordance with embodiments of the present disclosure;

FIG. 4 is a flow diagram of a method for configuring firewall rules using federated learning techniques while keeping firewall rules for each federated entity secret in accordance with embodiments of the present disclosure; and

FIG. 5 is a flow diagram of a method for configuring models for labelling and optimizing firewall rules in accordance with embodiments of the present disclosure.

It should be understood that the drawings are not necessarily to scale and that the disclosed embodiments are sometimes illustrated diagrammatically and in partial views. In certain instances, details which are not necessary for an understanding of the disclosed methods and apparatuses or which render other details difficult to perceive may have been omitted. It should be understood, of course, that this disclosure is not limited to the particular embodiments illustrated herein.

### DETAILED DESCRIPTION

Embodiments of the present disclosure provide systems, methods, and computer-readable storage media facilitating distributed learning techniques configured to streamline creation of firewall rules and optimize firewall rule sets utilized by different organizations without requiring those organizations to share their firewall rules. The disclosed embodiments utilize machine learning techniques to develop and train models that may be distributed to one or more different organization for purposes of training the model(s) and optimization/creation of firewall rules specific to each organization. Feedback may be generated by each different organization during training of the models and the feedback may be provided to a firewall analysis device (e.g., a device that generates and distributes the models). The firewall analysis device may use the feedback to refine model parameters and update the models (or generate a new model), which may be subsequently distributed to the organization(s) for use in creating new firewall rules or optimizing existing firewall rules. The disclosed techniques enable large sample sizes to be used to train models and refine them over time without requiring different entities to share firewall rules with other organizations (or with the firewall analysis device), thereby maintaining the confidentiality and privacy of each organization's firewall rules. Such techniques enable insights to be derived from each entity's firewall rules that may be used to more correctly label firewall rules with actions (e.g., allow or deny connections to specific network resources) and potentially reduce the number of firewall rules required to address certain portions of the address space covered by the firewall rules (e.g., use less rules to cover a group of IP addresses).

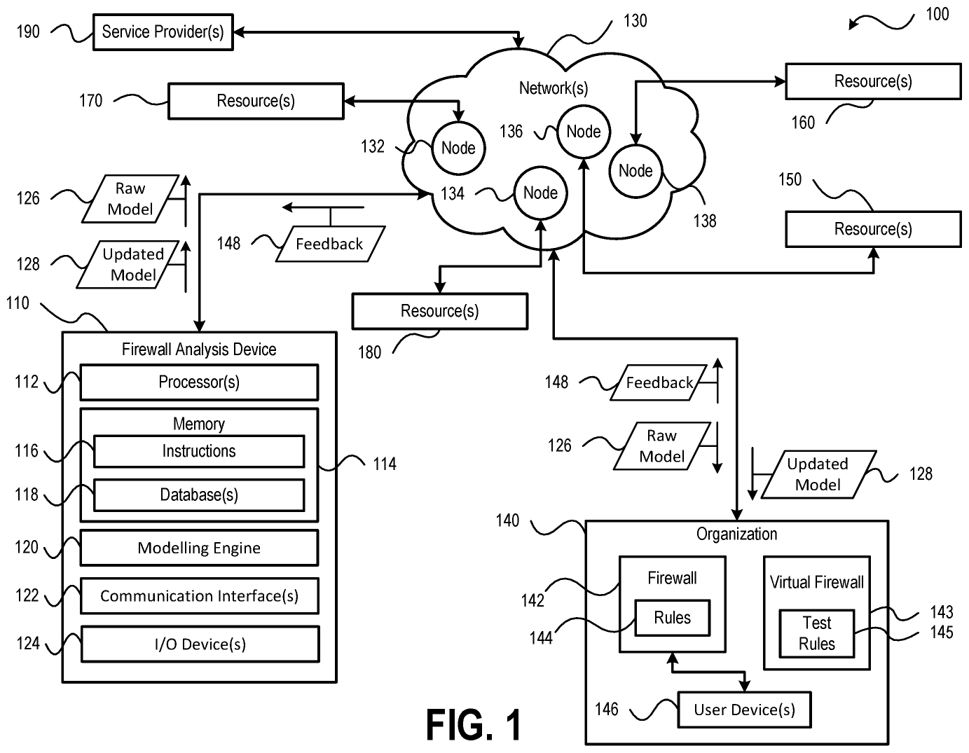

Referring to FIG. 1, a system for configuring firewall rules using federated learning techniques while keeping firewall rules for each federated entity secret in accordance with embodiments of the present disclosure is shown as a system 100. The system 100 may be configured to generate and distribute models to various organizations or entities to assist those organizations with configuring firewall rules. The models distributed by the system 100 may enable the various entities (e.g., individuals, businesses, etc.) to more easily configure firewall rules, as described in more detail below. As the entities use the models to configure their own firewall rules, feedback data may be generated and provided back to the system 100, where the feedback data may be used to train or update the model, thereby producing a new instance of the model that may be subsequently distributed to the various entities. Distribution of the model (and subsequently models updated based on the feedback data generated by the entities) to different entities may enable federated training of the model across a diverse set of input data (e.g., different entities may configure firewall rules differently to prevent access to different Internet resources and domains, which provides different sets of training data that may be used to update the model) without requiring the entities to share their data sets (e.g., the actual firewall rules of each entity) with other entities. Such capabilities enable the model to be dynamically trained and used across many different entities to configure firewall rules of varying complexity while maintaining data privacy with respect to each data set so as to prevent malicious actors from using the firewall rules to exploit each entity's network security policies.

As shown in FIG. 1, the system 100 includes a firewall analysis device 110. The firewall analysis device 110 includes one or more processors 112, a memory 114, a modelling engine 120, one or more communication interfaces 122, and one or more input/output (I/O) devices 124. The one or more processors 112 may include one or more microcontrollers, application specific integrated circuits (ASICs), field programmable gate arrays (FPGAs), central processing units (CPUs) having one or more processing cores, or other circuitry and logic configured to facilitate the operations of the firewall analysis device 110 in accordance with aspects of the present disclosure. The memory 114 may include random access memory (RAM) devices, read only memory (ROM) devices, erasable programmable ROM (EPROM), electrically erasable programmable ROM (EEPROM), one or more hard disk drives (HDDs), one or more solid state drives (SSDs), flash memory devices, network accessible storage (NAS) devices, or other memory devices configured to store data in a persistent or non-persistent state. Software configured to facilitate operations and functionality of the firewall analysis device 110 may be stored in the memory 114 as instructions 116 that, when executed by the one or more processors 112, cause the one or more processors 112 to perform the operations described herein with respect to the firewall analysis device 110, as described in more detail below. Additionally, the memory 114 may be configured to store one or more databases 118. Exemplary aspects of the one or more databases 118 are described in more detail below.

The one or more communication interfaces 122 may be configured to communicatively couple the firewall analysis device 110 to one or more networks 130 via wired or wireless communication links established according to one or more communication protocols or standards (e.g., an Ethernet protocol, a transmission control protocol/internet protocol (TCP/IP), an Institute of Electrical and Electronics Engineers (IEEE) 802.11 protocol, and an IEEE 802.16 protocol, a 3rd Generation (3G) communication standard, a 4th Generation (4G)/long term evolution (LTE) communication standard, a 5th Generation (5G) communication standard, and the like). The one or more input/output I/O devices 124 may include one or more display devices, a keyboard, a stylus, one or more touchscreens, a mouse, a trackpad, a camera, one or more speakers, haptic feedback devices, or other types of devices that enable a user to receive information from or provide information to the firewall analysis device 110.

The modelling engine 120 may be configured to generate and modify models configured to optimize firewall rules, where the firewall rules may be utilized to prevent computing devices of an entity from sending outgoing network communications to or receiving incoming network communications from malicious domains or Internet resources (e.g., botnets, spoofed IP addresses, and the like). The models generated by the modelling engine 120 may be generated based on information associated with the routable IP version 4 (IPv4) address space. In an aspect, the routable address space considered during generation of the model may be based on a plurality of IPv4 subnets to reduce the computational complexity of the model and enable improvements with respect to optimizing firewall rules for various entities (e.g., to enable creation of a sufficient number of firewalls rules while preventing crashes or otherwise negatively impacting the performance of the firewall and the systems that are supported by it). As an example, generation of the model may take into consideration all or a portion of the approximately 14.3 million routable IPv4/24 subnets on the Internet. It is to be understood that while subnets are primarily described herein with reference to IPv4/24 subnets, such description has been provided for purposes of illustration, rather than by way of limitation and other types of subnets may also be utilized according to aspects of the present disclosure, such as IPv4/16 subnets or other subnet configurations.

Exemplary features that may be analyzed and considered by the modelling engine 120 during generation of the models may include autonomous system numbers (ASNs), organizations (e.g., Internet service providers (ISPs), cloud hosting providers, commercial businesses, industry types, and the like), countries, cities, latitude and longitude data, ISP data, link type data (e.g., coax, broadband, aux, multiprotocol label switching (mpls), and the like), netblock type (e.g., assigned, dedicated, reserved, unspecified, dynamic, and the like), netblock description, net handle, net name, top domain name (e.g., the most common domain name, such as example.com), top ports (e.g., the most common port(s) found open on a subnet, such as 80 HTTP, 443 HTTPs, and the like), top services (e.g., the most common services available on hosts within a subnet, such as mail services, file transfer protocol (ftp) services, web services, and the like), to organization certifications (e.g., common certification types found on a subnet, such as self-signed local host certifications or extended validation certifications), top systems (e.g., common operating systems advertised on hosts of a subnet (e.g., Apache, Linux, Windows IIS, and the like), top vulnerabilities (e.g., common vulnerabilities exposures found on hosts within a subnet), or various combinations of two or more of these features. It is noted that the exemplary features identified above have been provided for purposes of illustration, rather than by way of limitation and other features may be considered during generation models for configuring and optimizing firewall rules in accordance with embodiments of the present disclosure. Table 1 below illustrates exemplary feature values that may be obtained for features associated with a portion of an IPv4/24 subnet (e.g., a portion corresponding to the subnet 104.24.112.0/24). It is noted that while the exemplary feature values illustrated in Table 1 do not include all of the features described above, such features may be considered by embodiments of the present disclosure and the exemplary values shown in Table 1 are shown for purposes of illustration, rather than by way of limitation.

TABLE 1

| | |
|---|---|
| ASN | AS13335 |
| ORG | Cloudflare |
| DOMAIN | cloudflare.com |
| COUNTRY | US |
| CITY | San Francisco |
| LAT/LONG | 37.7697, −122.3933 |
| ISP | Cloudflare |
| LINK | ? |
| orgRef.name | ? |
| handle | NET-104-16-0-0-1 |
| name | DS |
| orgRef.handle | CLOUDFLARENET |
| netBlocks.type | INTERNET |

As shown in Table 1, the feature values may enable the corresponding portion of the address space to be associated with a particular ASN (e.g., AS1335), a particular organization (e.g., Cloudflare), a domain (e.g., cloudflare.com), a country (e.g., the United States), a particular city (e.g., San Francisco), and so on. It is noted that some features may not be available depending on the service provider providing the features and the techniques used to derive the features, such as the LINK and orgRef.name features shown in Table 1 as including values of “?” (e.g., a NULL value).

In an aspect, the exemplary features described above (and/or other features) may be obtained from one or more service providers, such as the service provider(s) 190. Exemplary service providers that may provide at least portions of the above-mentioned features include service providers that periodically scan and profile all or portions of the Internet address space, such as Shodan (shodan.io), the Internet-Wide Scan Data Repository (scans.io), the ZMap Project (zmap.io), Censys (censys.io), NETDB (netdb.io), and Zoom Eye (zoomeye.org). Additionally it is noted that all or a portion of the features may be obtained via the firewall analysis device 110 in some implementations. For example, the firewall analysis device 110 may be configured to periodically scan and profile all or portions of the Internet address space. In still other implementations, some of the features may be obtained from the service provider(s) 190 and other features may be obtained via the firewall analysis device 110. To illustrate the concepts described above, the scanned IPv4/24 address space that is periodically scanned to obtain the above-identified features (or portions thereof) may be expressed as shown in Table 1 below.

```
TABLE 2
    1.0.0.0-9.255.255.255
    11.0.0.0-100.63.255.255
  100.128.0.0-126.255.255.255
    128.0.0.0-169.253.255.255
169.255.0.0-172.15.255.255
  172.32.0.0-191.255.255.255
192.0.1.0-192.0.1.255
  192.0.3.0-192.88.98.255
192.88.100.0-192.167.255.255
192.169.0.0-198.17.255.255
198.20.0.0-198.51.99.255
198.51.101.0-203.0.112.255
  203.0.114.0-223.255.255.255
```

It is noted that certain portions of the IPv4 address space are excluded from Table 2. For example, IP addresses from 10.0.0.0-10.255.255.255 may be excluded (e.g., from the periodic scanning to obtain the feature set) because those IP addresses are reserved for use in private networks, rather than for publicly accessible networks. Other portions of the total IP address space for IPv4 are also excluded in the example above for similar reasons. It is noted that periodic scanning of the IP address space to obtain feature sets helps in addressing problems associated with IP address changes and allows the model to be updated as changes in the IP address space are observed. For example, an IP address may initially be associated with features that indicate the address is associated with a first organization (i.e., the organization feature) and a subsequent scan of the address space may indicate that the IP address is associated with a second organization. When this occurs, the model may be updated to account for such changes, thereby enabling the model to adapt to changes that occur within the IP address space over time. Additionally, as the models are updated based on changes observed in the obtained feature sets over time, those changes may be pushed to the various organizations that use the model to configure and optimize their own firewall rules. This enables each organization that receives an instance of the model to configure firewall rules based on a current state of the IP address space covered by the model and mitigates the likelihood that a malicious actor is able to bypass firewall protections simply by changing IP addresses.

As briefly described above, the modelling engine 120 may be configured to generate and update models that enable firewall rules to be configured and optimized. To generate the model, the modelling engine 120 may first vectorize the feature set associated with the IP address space considered by the model. During vectorization, the features may be converted into numerical values suitable for use with the model. The generated model may be a raw model, such as raw model 126. Once generated, the firewall analysis device 110 may transmit the raw model 126 to one or more organizations, such as organization 140, via the one or more networks 130.

As shown in FIG. 1, the organization 140 may include one or more user devices 146 and a firewall 142 having a plurality of firewall rules 144. The user device(s) 146 may provide users (e.g., employees of the organization, etc.) with access to network-based resources, such as web services and applications. The firewall rules 144 may be maintained by one or more users of the organization 140, such as information technology (IT) personnel. Additionally, the firewall rules 144 may provide a network policy that controls whether incoming and outgoing connections between user devices, such as the one or more user device 146, of the organization 140 and various network resources. Exemplary concepts of firewall rules that may be included in the firewall rules 144 are shown in Table 3 below.

TABLE 3

| Rule No. | Protocol | Source IP | Destination IP | Destination Port | Action |
|---|---|---|---|---|---|
| 1 | TCP | 10.1.1.1 | 20.1.1.1 | 80 | Accept |
| 2 | TCP | 10.1.1.2 | 20.1.1.1 | 80 | Deny |
| 3 | TCP | 10.1.1.0/24 | 20.1.1.1 | 80 | Deny |
| 4 | TCP | 10.1.1.3 | 20.1.1.1 | 80 | Accept |
| 5 | TCP | 10.2.2.0/24 | 20.2.2.5 | 80 | Deny |
| 6 | TCP | 10.2.2.5 | 20.2.2.0/24 | 80 | Deny |
| 7 | TCP | 10.3.3.0/24 | 20.3.3.9 | 80 | Accept |
| 8 | TCP | 10.3.3.9 | 10.3.3.0/24 | 80 | Deny |
| 9 | IP | 0.0.0.0/0 | 0.0.0.0/24 | 0-65535 | Deny |

As shown in Table 3 above, 9 exemplary firewall rules that may be configured in the firewall rules 144 are shown. The rules may specify various features (e.g., protocol, source IP, destination IP, and a destination port) for connections and a label that specifies an action to be taken by the firewall 144 when a connection to a network resource covered by the firewall rules 144 is detected by the firewall. For example, if a connection from source IP 10.1.1.1 to destination IP 20.1.1.1 on port 80 using TCP was detected, the firewall 144 may detect that this connection is addressed by rule number 1 of Table 3 and accept the connection (e.g., allow the connection between the source and destination IPs to occur) based on the label assigned to the relevant rule. On the other hand, if the source IP for the detected connection to destination IP 20.1.1.1 was 10.1.1.2 instead of 10.1.1.1, the firewall 144 may deny the connection based on rule number 2, which is labeled with the action “Deny”. It is noted that the exemplary concepts described above with reference to Table 3 have been provided for purposes of illustration, rather than by way of limitation and that the concepts disclosed herein may be readily utilized with firewall rules that are different from those provided in the examples above. Also, it is noted that the exemplary features included in the firewall rules of Table 3 are provided as non-limiting examples and that firewalls rules may include more features, fewer features, or additional features than those listed in Table 3.

The network resources to which the user devices 146 may attempt to connect may be hosted on or provided by various nodes accessible via the one or more networks 130. For example, FIG. 1 illustrates a node 132 associated with a network resource 170, a node 134 associated with a network resource 180, a node 136 associated with a network resource 150, and a node 138 associated with a network resource 160. Each of the network resources 150, 160, 170, 180 may provide services and other types of functionality to the users operating the user devices 146. For example, the network resources may include cloud services, websites, content distribution networks, or other types of resources that users may desire access to via the one or more networks 130. The firewall rules 144 may specify rules that include labels that dictate how the firewall should handle attempts to establish connections with some or all of the nodes 132, 134, 136, 138. For example, features indicative of an outgoing connection between a user device of the organization 140 and the node 132 may be labeled by the firewall rules 144 with an action that either allows or denies the connection. If the connection is labeled in the firewall rules 144 with an allow action, the user device(s) 146 may be able to establish the outgoing connection to the node 132 (e.g., to access the network resource 170). However, if the connection is labeled with a deny action, attempts by the user device(s) 146 to establish the outgoing connection to the node 132 may be denied, thereby preventing the user device(s) 146 from accessing the node 132 and the network resource 170.

Upon receiving the raw model 126, it may be trained based on at least a portion of the firewall rules 144. Depending on the level of sophistication of the organization 140 and its IT personnel that manage the firewall 142, the firewall rules 144 may include a large dataset of firewall rules that are available for potential use in training the raw model 126 or a small dataset of firewall rules. For example, sophisticated organizations may configure the firewall rules 144 with up to approximately 65,000 rules, while less sophisticated organizations may have far fewer firewall rules (e.g., 30,000 firewall rules, 16,000 firewall rules, or less) due to the complexities associated with creating firewall rules. In an aspect, only a portion of the firewall rules 144 may be used for training the raw model 126. For example, the firewall rules 144 may include one or more firewall rules that the organization's IT personnel are confident correctly label malicious connections within an address space (e.g., an address space covered by the firewall rules 144) and the dataset used to train the raw model 126 may only include those rules. In an aspect, the firewall rules 144 may include a score (e.g., a confidence score) that indicates a confidence level that the IT personnel have with respect to each firewall rule and selection of the training dataset may be based on the scores, such as to select firewall rules for inclusion in the training dataset that satisfy a threshold score (e.g., 75%, 80%, 85%, 90%, 95%, 100%, or other scores).

Once the training dataset is selected, the training dataset may be used to train the raw model 126. During the training of the raw model 126, model parameters may converge to particular values. The particular amount of time associated with the training period may be an hour, 3 hours, 6 hours, 12 hours, 1 day, 3 days, five days, 1 week, multiple weeks (e.g., 2-3 weeks), 1 month, and the like. Based on the training of the raw model 126, a new set of hyperparameters for the raw model 126 may be generated. In an aspect, the hyperparameters may be specified as numeric values and may represent labels (e.g., actions) that may be applied to one or more firewall rules considered by the models generated by the modelling engine 120. For example, a first hyperparameter value may be indicative of a firewall rule labeled with an action to deny a particular connection between a source and destination address within the address space while a second hyperparameter value may be indicative of a firewall rule labeled with an action to allow a particular connection between a source and destination address within the address space.

The hyperparameters generated based on the training of the raw model 126 may be provided as feedback 148 to the firewall analysis device 110. The firewall analysis device 110 may be configured to generate an updated raw model based on the hyperparameters included in the feedback 148 and the updated model 128 may be transmitted to the organization 140 for further training based on the firewall rules 144. The updated hyperparameters of the model may be used to control labels inputs provided to the model(s), as described above, and changes to the hyperparameters based on the feedback may eventually converge to a value that correctly labels inputs (e.g., to allow or deny connections corresponding to the inputs).

In addition to training the raw model 126 and the updated model 128 based on the firewall rules 144, the organization 140 may also use the raw model 126 and the updated model 128 to configure the firewall rules 144. To illustrate, the organization 140 may provide an input to the raw model 126 and the updated model 128 and the model may output a label (e.g., an allow action or a deny action) for each input. The outputs generated by the model(s) may be used to generate one or more firewall rules that may be incorporated into the firewall rules 144. As described above, due to the difficult nature of configuring firewall rules, there are many organizations that simply allow connections, which could result in connections being established between user devices of those organizations and malicious network resources (e.g., botnets, etc.). In such situations, the raw model 126 and the updated model 128 may enable creation of firewall rules that cover portions of the address space known to be associated with malicious network resources or domains, thereby enabling those rules to be incorporated into the firewall rules 144. In an aspect, the input provided to the model may be the firewall rules 144. In an additional or alternative aspect, the input may be a traffic flow of the organization 140, such as traffic flows associated with the user device(s) 146 or other computing devices utilized by the organization 140 (e.g., traffic flows associated with connections to web servers, routers, etc. of the organization 140).

In an aspect, IT personnel of the organization 140 may perform testing prior to incorporating firewall rules generated based on the raw model 126 or the updated model 128 into the firewall rules 144. For example, rules generated based on the raw model 126 and the updated model 128 selected for incorporation into the firewall rules 144 may be provided to a virtual firewall 143 as a set of test rules 145. Traffic flows (both incoming and outgoing) of the organization 140 may be fed to the virtual firewall 143 to evaluate how the set of test rules 145 will impact performance of the organization 140's networks and traffic, such as to see if the set of test rules 145 will crash the firewall or otherwise degrade performance, prevent access to desired network resources, or for other purposes. If the testing is satisfactory (e.g., no negative impact on the traffic flows), the set of test rules 145 may be incorporated into the firewall rules 144 where they may then be used to allow or deny live traffic.

In an aspect, the firewall rules generated based on the models may include scores that indicate a likelihood that the firewall rules correctly label connections that should be denied and connections that should be allowed. When incorporating rules from the model into the rules 144, the IT personnel (or automated software for updating the firewall rules 144) may select rules of the model that satisfy a threshold score. For example, suppose the score for a rule generated based on the model indicates a 90% likelihood the rule is configured correctly. During testing of the rule via the virtual firewall 143, the IT personnel may determine a modified score, such as to increase the score (or decrease the score). If the rule is incorporated into the firewall rules 144 following testing, the score generated based on the model or the modified score determined based on the testing may also be incorporated into the firewall rules 144.

The models generated by the modelling engine 120 may be periodically updated based on feature data obtained from the one or more service providers 190 (and/or functionality of the firewall analysis device 110 for obtaining features). For example, feature sets may be periodically obtained (e.g., once every 4 days, once per week, once every two weeks, once a month, or some other time interval) and applied to the models (e.g., the raw model 126, the updated model 128, or subsequently updated models generated based on feedback from one or more previous models). Periodically updating the model based on current feature sets may enable changes to the address space within the scope of the models to be identified and accounted for by the modelling engine 120. To illustrate, suppose that an IP address (or domain) was associated with a first entity in a first feature set and based on the training of the model connections to that IP address (or domain) were labeled with a deny action (e.g., the first entity is a known malicious entity). If a subsequently obtained feature set indicates that the IP address (or domain) is no longer associated with the first entity and is instead associated with a second entity, the model may be updated to account for the change in entity associated with the IP address.

In aspects, when a change in an entity (or other feature) associated with an IP address or domain is detected (e.g., based on a newly obtained feature set), portions of the current model associated with that IP address or domain may be modified to produce a next iteration of the updated model that may be distributed to one or more organizations, such as the organization 140. Modifications to the model may include adjusting a label associated with the IP address or domain, deleting portions of the model applicable to the IP address or domain, modifying a score associated with the IP address or domain, or other actions. It is noted that removing the label may be problematic since this would allow an entity known to be malicious to simply release the IP address or create a new entity, and obtain the IP address or domain with the newly created entity to bypass firewalls. Thus, modifying the score may provide a better approach to handle entity changes. For example, suppose that a score for the IP address or domain indicating that the entity was a known malicious actor and connections to the IP address or domain should be denied. When the new entity is detected as being the owner of the IP address or domain, the score for the IP address or domain may be reduced, which may indicate that the IP address or domain is now not known to belong to a malicious actor. Thus, it may be less likely that any rules present in the model will be incorporated into the firewall rules of any organizations utilizing models generated by the modelling engine 120, or at least incorporating the rule without testing.

Over time, the model data may be modified based on feedback from the organization 140 (or other organizations supported by the firewall analysis device 110). For example, suppose that the organization 140 tests the firewall rule and determines that the IP address or domain of the second entity is not malicious. The organization 140 may generate a rule that allows connections to the IP address or domain and feedback may be provided to the firewall analysis device 110. That feedback may be used to update the model, such as to lower the score further to indicate there is a reduced likelihood that the IP address or domain is associated with a malicious actor. If feedback for the IP address or domain received from other organizations also indicates the second entity is not a malicious actor, the portion of the model associated with that IP address or domain may eventually be modified to have a different label, such as a label having an allow action (e.g., a rule that allows connections to the IP address or domain). When the label change occurs, the updated model may initially have a low score, but over time that score may increase based on the feedback received from the organizations and may eventually reach a score that indicates a high likelihood that the IP address or domain is not associated with a malicious actor. It is to be understood that while the example above illustrates concepts related to a known malicious network resource changing to a known non-malicious network resource and updating firewall rules to reflect such change, those concepts may also be utilized in the opposite direction (e.g., a network resource associated with known non-malicious actor may subsequently become associated with a malicious actor and the techniques described above would result in a model that includes rules denying connections to the network resource).

Using the techniques described above, changes to the network resources (e.g., IP addresses, domains, etc.) within the address space covered by the model may be taken into account and dynamically updated based on feedback received from one or more organizations. The changes to the model may be incremental changes to prevent malicious actors from simply changing features associated with the network resource (e.g., entity name, location, IP address, etc.) to bypass firewall rules. For example, reducing the score to indicate a reduced likelihood the network resource is malicious may prevent organizations from immediately allowing connections to that network resource just because certain features associated with the network resource have changed. The system 100 relies on testing and feedback from the organizations over time to dictate whether the network resources transition from known-malicious resources (e.g., resources labeled with deny actions) to a potentially non-malicious resource and eventually to a known non-malicious resources (e.g., resources labeled with allow actions) or vice-versa. Such techniques provide a dynamic technique for real-time monitoring for changes to features of network resources within an address space (e.g., the IPv4 address space) and accounting for those changes within firewall rules in a way that reduces a likelihood that malicious actors can bypass firewall rules through manipulation of network resource features (e.g., changes to the all or some of the features indicated in Table 1.

As shown above, the system 100 enables models to be created and provided to an organization to aid in configuration of firewall rules, such as by incorporating rules generated based on the model into firewalls of an organization. Moreover, the models may be trained using local datasets of firewall rules (e.g., firewalls local to the organization receiving the model). To improve the training of the models, the training data may be selected based on firewall rules associated with a score indicative of a likelihood the firewall rule or rules is/are configured correctly (e.g., allows non-malicious connections or denies malicious connections). Using training data that has been vetted based on some measure of accuracy to train the model may enable the model to become more accurate over time (e.g., only rules having a high likelihood of correctly blocking malicious connections). Additionally, based on the training of the models using local datasets, feedback (e.g., hyperparameters) may be generated that may be provided to the firewall analysis device 110 and used to make changes to how the model suggests labels for firewall rules. Notably, the feedback enables organizations to share information about how a firewall is configured without having to share the firewall rules, thereby preserving the privacy of the organizations' firewall rules and preventing knowledge of the rules from being used to circumvent or bypass the organizations' firewalls. Moreover, the system 100 provides techniques for monitoring changes to features of network resources within an address space (e.g., the IPv4 address space) and reflecting those changes in firewall rules, which allows one or more organizations supported by the system 100 to keep their firewall rules up-to-date with the current state of the address space.

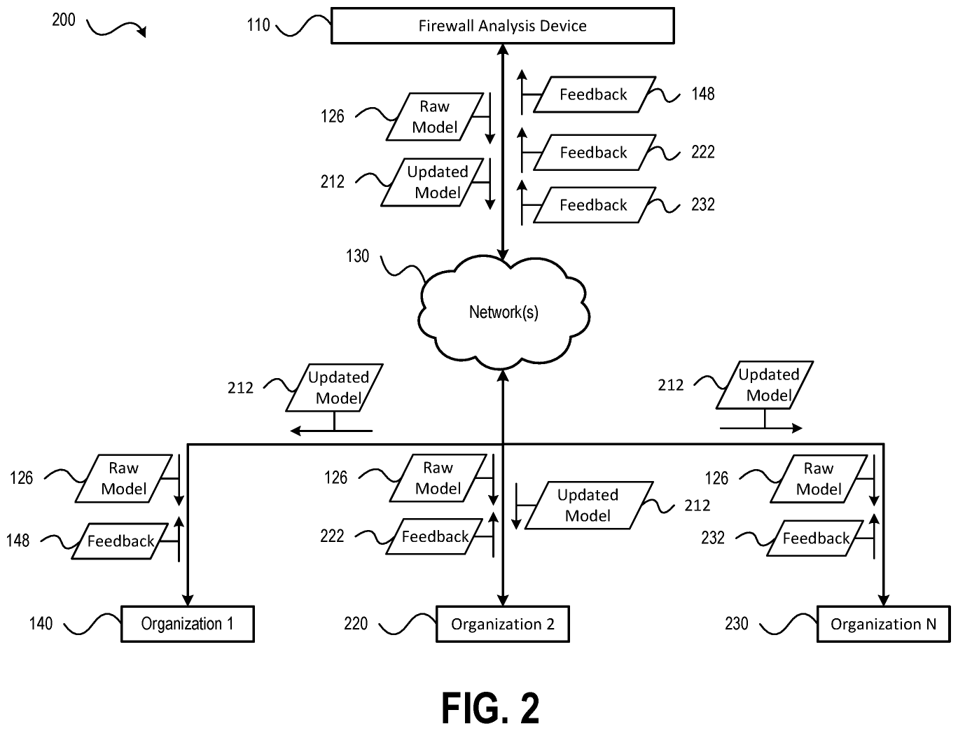

It is noted that FIG. 1 shows a single organization 140 for purposes of illustration, rather than by way of limitation, and that aspects of the present disclosure may be readily applied across a plurality of organizations and entities (e.g., businesses, individuals, etc.) to enable federated learning and training of models in order to configure and optimize firewall rules. For example, and referring to FIG. 2, a block diagram illustrating aspects of a system for performing distributed training of models and configuration of firewall rules in accordance with embodiments of the present disclosure is shown as a system 200. It is noted that FIGS. 1 and 2 use like reference numbers to represent the same or similar components except where otherwise noted. Further, it is noted that the concepts described and illustrated with respect to the system 200 of FIG. 2 may be implemented and utilized by the system 100 of FIG. 1 and vice versa.

As shown in FIG. 2, the system 200 includes the firewall analysis device 110 in communication with N organizations (N>1) via the network 130. The N organizations include the organization 140 of FIG. 1, an organization 220, and an organization 230. Although not illustrated in FIG. 2 to simplify the drawing, the organizations 220, 230 may include firewalls and firewall rules similar to those described above with reference to FIG. 1.

As described above with reference to the system 100 of FIG. 1, the firewall analysis device 110 may generate the raw model 126, which may be a global model (e.g., a model that is distributed to all organizations supported by the system 200), and distribute the raw model 126 to each of the organizations 140, 220, 230. Once provided to the organizations 140, 220, 230, instances of the raw model 126 at each of the different organizations may be separately trained using local datasets that include firewall rules for each organization. To illustrate, the organization 140 may train the raw model 126 using a dataset of training data derived from the firewall rules 144, as described above with reference to FIG. 1. Similarly, the organization 220 may train the raw model 126 using a dataset of training data derived from firewall rules selected from the firewall of the organization 220 and the organization 230 may train the raw model 126 using a dataset of training data derived from firewall rules selected from the firewall of the organization 230. In addition to training the raw model 126, the N organization may also incorporate one or more firewall rules of the raw model 126 into their respective sets of firewall rules, as described above with reference to FIG. 1.

As described above, hyperparameters may be generated as the raw model 126 is trained by each organization and the hyperparameters may be provided to the firewall analysis device 110 as feedback. For example, the organization 140 may provide the hyperparameters to the firewall analysis device 110 as feedback 148, as described above with reference to FIG. 1, the organization 220 may provide hyperparameters generated during local training by the organization 220 to the firewall analysis device 110 as feedback 222, and the organization 230 may provide hyperparameters generated during local training by the organization 230 to the firewall analysis device 110 as feedback 232. It is noted that the feedback 148, 222, 232 may not include the actual firewall rules used by the firewalls of each of the organizations 140, 220, 230 or the specific rules used in the training datasets to locally train the raw model 126. Thus, the system 200 facilitates training of the raw model 126 in a federated manner without requiring firewall rules to be shared outside of an organization. This capability enables entities to share information characteristic of the configuration of their firewalls without creating a risk that the shared information can be used to bypass the firewall rules used by each of the organizations 140, 220, 230, thereby solving problems that would arise from sharing firewalls rules using currently available techniques.

The feedback 148, 222, 232 may be received by the firewall analysis device 110 and used to create an updated global model having a new set of model parameters generated based on the feedback. For example, as briefly described above, the models generated by the firewall analysis device 110 may be configured to include a set of parameters that may converge to particular values over a training period. The values to which the model parameters converge may be different for each of the organizations 140, 220, 230 during a particular training period. The feedback 148, 222, 232 received for that training period may contain the different converged values for the model parameters and the different converged values may be used to calculate new parameter values for the updated global model.

The values of the hyperparameters included in the feedback may be processed by the firewall analysis device 110 prior to generating the updated global model. For example, the firewall analysis device 110 (e.g., the modelling engine 120) may compile aggregate parameter values based on the feedback. In an aspect, aggregation of the parameter values may include averaging the feedback received from each entity. For example, parameters values corresponding to a same aspect of the model (e.g., a same firewall rule) may be averaged to obtain an average parameter value and the average parameter value may be used to generate the updated global model. It is noted that in this example each of the parameter values received via the feedback may be weighted equally; however, such an example is provided for purposes of illustration, rather than by way of limitation and various techniques may be employed by the firewall analysis device 110 to weight feedback received from different entities differently, as described in more detail below.

In an aspect, the parameter values indicated in the feedback may be weighted based on characteristics of the entities providing the feedback. The characteristic may be associated with a size of the entities, a traffic volume of the entities (e.g., a volume of incoming and outgoing network connections), information regarding the accuracy of malicious network resource identification techniques used by the entities, or other types of characteristics. As an example of weighting the feedback parameter values based on a size of the entities, large entities may be more prone to receiving malicious incoming connections as compared to similar smaller-sized entities due to the increased likelihood that the larger entities may have more data of interest to hackers, such as a database of subscriber information (e.g., credit card numbers, subscriber addresses (physical addresses and/or electronic addresses), financial account information (e.g., a financial institution may maintain information regarding customer bank accounts, financial card numbers, and the like), or other types of information that may be of interest to a malicious actor. Entities having a higher risk of being targeted by malicious actors, such as hackers, may have more sophisticated processes for identifying malicious network resources and may more accurately configure firewall rules to target connections between the organization and those malicious actors. In such a scenario, the weighting of the feedback parameter values may give more weight to feedback received from larger entities as compared to smaller entities that may have less capability to identify malicious network resources and may not be able to configure firewall rules as accurately as the larger entities. On the other hand, weighting the feedback parameters values based on the size of an entity may also be configured to attribute more weight to feedback parameters received from smaller entities because they may be targeted more frequently by different types of connections to malicious actors. For example, a large e-commerce organization may experience many incoming connections from malicious actors and have sophisticated and accurate firewall rules to address malicious incoming connections to the organizations networks. However, smaller organizations may have more exposure to malicious outgoing connections, such as being the target of botnets, and may configure accurate firewall rules for outgoing connections. It is noted that the examples provided above have been provided for purposes of illustrating concepts for applying weights to feedback received following training of a model in accordance with the present disclosure, rather than by way of limitation and that other factors may be utilized determine the weights that are applied to the feedback received from the different organizations supported by the system 200.

Once the feedback is received and processed (e.g., aggregated, weighted, etc.), an updated global model 212 may be generated. As shown in FIG. 2, the updated global model may be transmitted to the N organizations via the one or more networks 130. The updated global model 212 may then be used by each of the N organizations to repeat the processes described above. For example, each of the organizations 140, 220, 230 may train the updated global model 212 using a local dataset of firewall rules and incorporate one or more rules of the updated global model 212 into their local sets of firewall rules, as described above with reference to FIG. 1. This process may continue over time and enable the N organizations to develop robust firewall rules that accurately address malicious network resources in the address space without requiring each organization to have expert knowledge of how to configure firewall rules.

In addition to enabling organizations to more easily configure firewall rules, the firewall analysis device 110 may also be configured to optimize the firewall rules. For example, each time the firewall analysis device 110 or the modelling engine 120 generates an updated model, the model may be analyzed to identify instances where multiple rules can be consolidated. For example, over time different organizations may identify different IP addresses (or domains) as malicious via the hyperparameters and the model may be updated to label those IP addresses (or domains) with deny actions. The firewall analysis device 110 may identify a group of rules created in this manner that can be consolidated into a single rule, such as by grouping those IP addresses (or domains) within a firewall rule. Such consolidation enables a single rule to replace multiple rules, thereby creating a smaller rule set while still providing the same firewall protections and permissions with respect to those IP addresses (or domains).

Over time, the consolidation of rules may enable entities that previously were unable to add more firewall rules (e.g., due to the limitations of currently available firewall systems that are limited to approximately 65,000 rules or less) to expand their firewall rule sets. For example, suppose an organization had reached the limits of its firewall rules and that adding additional firewall rules would degrade the performance of the organization's systems or crash the firewall. Using the techniques described above, the firewall rules of that organization may be consolidated and space for additional rules may be created without degrading the performance of the firewall or the protections it provides. Notably, some of the capabilities to consolidate the organization's firewall rules may not be the direct result of training by that organization, but instead may come from training performed by other organizations. To illustrate, suppose organization 220 was limited to approximately 16,000 firewall rules due to the particular implementation of their firewall. Feedback provided by the organization 140 and/or the organization 230 may be used by the firewall analysis device to consolidate firewall rules of the model that cover many of the firewall rules of the organization 220, although the firewall analysis device 110 may not have direct knowledge of the firewall rules of the organization 220 when updating the model based on the feedback. When the updated global model having data associated with the consolidated firewall rules is received by the organization 220, the consolidated rules may be incorporated into the firewall rules of the organization 220, such as to replace 5 separate rules with a single rule that addresses the connections associated with those 5 separate rules.

It is noted that the models utilized by embodiments of the disclosure may utilize machine learning techniques to analyze firewall rules and determine labels that should be output for a given set of inputs (e.g., a training dataset of firewall rules, traffic flows, etc.). It is noted that the particular model parameters and the data types accepted as inputs by the models may depend on what classification/clustering machine learning algorithms are used. For example, where neural network models are utilized, the parameters may be biases (e.g., a bias vector/matrix) or weights and where regression-based machine learning algorithms are used the parameters may be differential values. Regardless of the particular type of machine learning algorithm(s) that are utilized, these hyperparameters may be used to update the model according to the concepts disclosed herein. In some aspects, the machine learning techniques may be used to identify and consolidate rules by creating new groupings, which may decrease the number of firewall rules needed to cover a portion of the address space addressed by the model. In turn, decreasing the number of firewall rules needed may enable the firewall to run more efficiently (e.g., by moving below the upper limits of the capabilities of the firewall, such as going from 65,000 rules to 64,000 rules) and/or make space for additional firewall rules that may be used to expand the security provided by a firewall. It is also noted that both supervised and unsupervised training techniques may be utilized to train models of embodiments.

As shown above, embodiments of the present disclosure may enable training of models configured to identify and label an address space (e.g., the IPv4 address space) in a coordinated and distributed manner. Moreover, the training of the models enables improvements to updated hyperparameters to be generated and provided to the firewall analysis device 110 for use in generating updated global models that may be subsequently distributed to participating organizations and entities to improve the creation and labelling of firewall rules. Additionally, all of the operations of the system 200 may be performed without requiring sharing of firewall rules between the different organizations or between any of the organizations and the firewall analysis device 110, thereby maintaining the confidentiality of each entity's firewall rules and preventing those rules from being misappropriated by malicious actors (e.g., using knowledge of shared firewall rules to bypass firewall security measures).

It is noted that the various embodiments illustrated and described with reference to FIGS. 1-2 may be utilized across many different organizations, each of which may have different firewall configurations and capabilities (e.g., some organizations may have firewalls that can support up to approximately 65,000 firewall rules while other organizations may have firewalls that can support 16,000 or fewer rules). Regardless of the capabilities of the firewalls used by the different organizations, the embodiments illustrated in FIGS. 1 and 2 may enable those organizations to more efficiently configure and optimize their firewalls rules. Also, because feedback from multiple organizations is utilized to generate updated global models, feedback from one organization or a small number of organizations may enable establishment of firewall rules to address potentially malicious network traffic at other organizations that may lack the ability to detect or configure firewalls rules to address that traffic without requiring those organizations to share firewall rules. This may enable rapid identification among the participating organizations of emerging threats despite no direct contact between the organizations. Also, it is to be understood that during a given training period, each participating organization may be using the same model or instance(s) of the global model (i.e., all organizations receive the same model each time a new update is made), which may be replaced with an updated or new model following the end of the current training period. The particular length or duration of a training period may fluctuate over time. For example, while a typical training period may have a duration of 1 week in order to capture changes to the features of the address space and provide time for testing and implementation of firewall rules to the live firewall rule sets, the duration may be adjusted periodically.

Additionally, it is noted that although FIGS. 1 and 2 illustrate the firewall analysis device 110 as being a standalone device, embodiments of the present disclosure may utilize multiple firewall analysis devices 110. Additionally, the functionality provided by the firewall analysis device 110 may be deployed in a cloud configuration, rather than via a server or other type of physical device. In such an arrangement, the functionality provided by the firewall analysis device 110 may be provided via computing resources disposed on a network (e.g., in the cloud). Utilizing a cloud-type configuration may enable systems operating in accordance with the present disclosure to scale more efficiently and in a cost effective manner. For example, where the firewall analysis device 110 is provided via a server, additional capacity may require an additional server capable of performing the functions of the firewall analysis device to be held on standby. When not in use, this additional server may sit idle, resulting in inefficient use of the computing resources of the server and increasing the overhead of the system. In contrast, where the firewall analysis device is deployed in the cloud, computing resources may be allocated to the functions of the firewall analysis device as additional computational power is needed and then deallocated (or reallocated) to other systems or functionalities when not in use (e.g., cloud service providers often charge based on the use of computing resources so unused computational resources may not result in increased overhead to the operator of the firewall analysis device and may not sit idle when not used to provide functionality of the firewall analysis device). It is noted that regardless of its physical deployment structure (e.g., deployment on one or more servers of a cloud-based configuration), the firewall analysis device 110 may be operated as a trusted coordinator or aggregator, such as an entity or service provider that is trusted to oversee creation, updating, and distribution of the models by the organizations that utilize the models to configure and optimize firewalls.

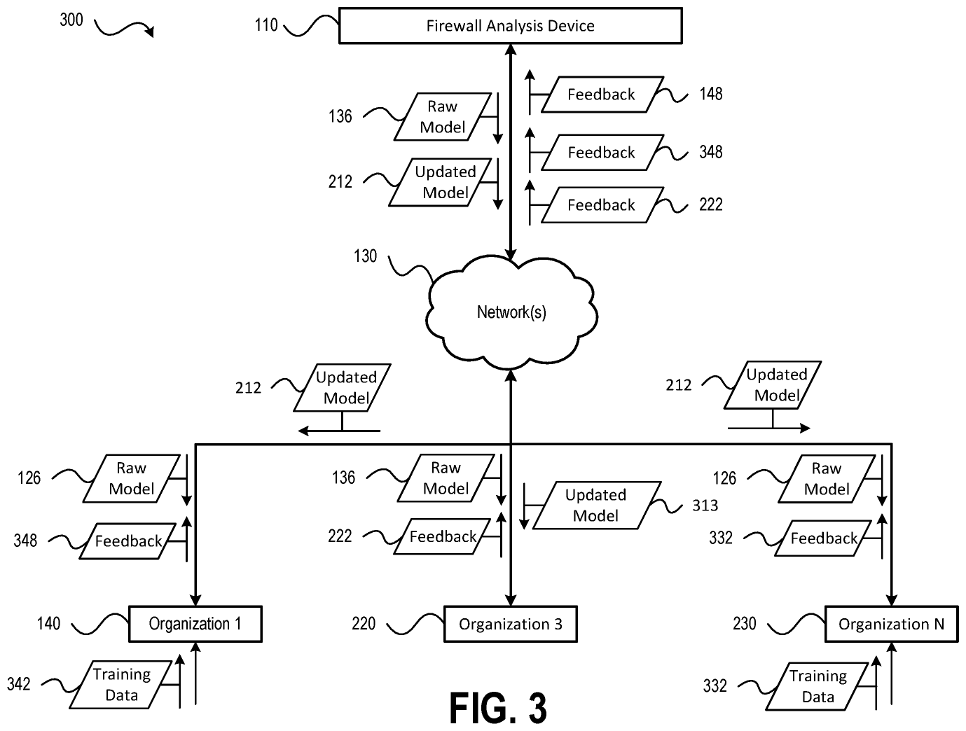

Referring to FIG. 3, a block diagram illustrating additional aspects of a system for utilizing models to configure and optimize firewall rules in accordance with aspects of the present disclosure is shown is shown as a system 300. It is noted that FIGS. 1-3 use like reference numbers to represent the same or similar components except where otherwise noted. Further, it is noted that the concepts described and illustrated with respect to the system 300 of FIG. 3 may be implemented and utilized by the system 100 of FIG. 1, the system 200 of FIG. 2, and vice versa. As shown in FIG. 3, the system 300 includes the firewall analysis device 110 in communication with N organizations (N>1) via the network 130. The N organizations include the organization 140 of FIG. 1, the organization 220 of FIG. 2, and the organization 230 of FIG. 2.

In the embodiment illustrated in FIG. 3, training of the models (e.g., the raw model 136 and subsequently generated updated models) may be performed using additional training data, such as training data other than firewall rules selected from the local firewall rules of each organization. For example, the organization 140 may train the models based on the firewall rules 144, as described above, and may also utilize additional training data 342. Similarly, the organization 230 may train the models based on local firewall rules of the organization 230, as described above, and additional training data 332. The additional training data 332, 342 may include training data other than firewall rules. For example, the training data 332, 342 may include web traffic proxy logs, netflow data, application logs, e-commerce logging data, distributed denial of service (DDoS) attack data, anti-virus alerts, security incident tickets, Snort alerts or logs, or other types of data. Some of the additional training data 332, 342 may include data representative of malicious activity (e.g., illegitimate IP traffic training data), such the DDoS attack data, the anti-virus alerts, security incident tickets, and Snort alerts or logs, while other portions of the training data 332, 342 may include data representative of non-malicious activity (e.g., legitimate IP traffic training data), such as the web traffic proxy logs, netflow data, application logs, and e-commerce logging data. It is noted that many of these additional training data sources may include features that are not present in the features received from the service providers 190 of FIG. 1. These additional features may provide a better understanding of the address space and improve the model's ability to identify appropriate labels for managing firewall rules related to the address space. For example, the additional features may include: information provided by a proxy, which may label IP addresses which are TOR (The Onion Routing) nodes, IP addresses labeled by mail gateways as having poor email reputation (e.g., high spam), IP addresses labeled as part of a botnet by anti-virus tools, successful e-commerce sales which don't trigger fraud/charge-backs may generate logs of IP addresses/subnets where you have had known good customers (e.g., IP addresses having good labels). It is noted that while the additional training data sources may provide additional features, there may be some overlapping or common features between the additional training data sources and the training data described above with reference to FIGS. 1 and 2.

Information from these additional data sources may be fed to the model(s) during a training period to provide additional sources of data that may be used to generate and provide feedback to the firewall analysis device 110. For example, the organization 140 may train the model using the firewall rules 144 of FIG. 1 and the training data 342 and based on the training may generate feedback 348. Similarly, the organization 230 may train the model using its firewall rules and the training data 332 and based on the training may generate feedback 332. It is noted that not every organization supported by the firewall analysis device 110 is required to use these additional types of training data. In the embodiment illustrated in FIG. 3, the organization 220 may not utilize these types of additional data sources or may elect not to utilize those information sources (even if they are available for use) to train the models received from the firewall analysis device.

Utilizing the additional training data 332, 342 may enable updates to the models based on feedback that can account for more types of malicious traffic that may be experienced by the organizations supported by the firewall analysis device 110. Additionally, the additional training data may enable the models to realize improved capabilities to discriminate between malicious traffic and non-malicious traffic, thus enabling firewall rules to be created with labels that more accurately allow or deny traffic that is non-malicious or malicious, respectively.

It is noted that while the exemplary features and functionality illustrated in FIGS. 1-3 have been described with reference to the IPv4 address space, embodiments are not limited to the IPv4 address space. For example, the IPv6 address space is significantly larger than the IPv4 address space and presents an even more complex challenge with respect to attempting to configure firewall rules, likely beyond the capability of firewall security appliances presently available. Thus, trying to configure a meaningful set of firewall rules for the IPv6 address space would be difficult even for the most sophisticated firewall systems and IT administrators of today. However, the techniques described herein may enable firewall rules for the IPv6 address space to be developed over time and using collaborative and federated learning, where individual organizations may contribute to training models to create firewall rules for different portions of the IPv6 address space. The disclosed techniques may enable more rapid creation of accurate firewall rules for the IPv6 address space and at a minimum allow meaningful firewall rules to be generated for IPv6 firewalls. An additional challenge that may be solved for IPv6 firewalls by the present disclosure is updating firewall rules. It is envisioned that as technology continues to advance, firewalls capable of supporting more than 65,000 firewall rules will become available. However, maintaining such a large volume of firewall rules, which need to be frequently reviewed, updated, and changed, will become more time consuming and difficult. Embodiments of the present disclosure may enable rapid development of firewall rules, testing of those rules, and maintenance of those rules using the models and techniques described herein. Accordingly, while presently available firewalls and the hardware that support them constrain firewalls to approximately 65,000 firewall rules, the models of embodiments may be capable of handling significantly more than this number of firewall rules.

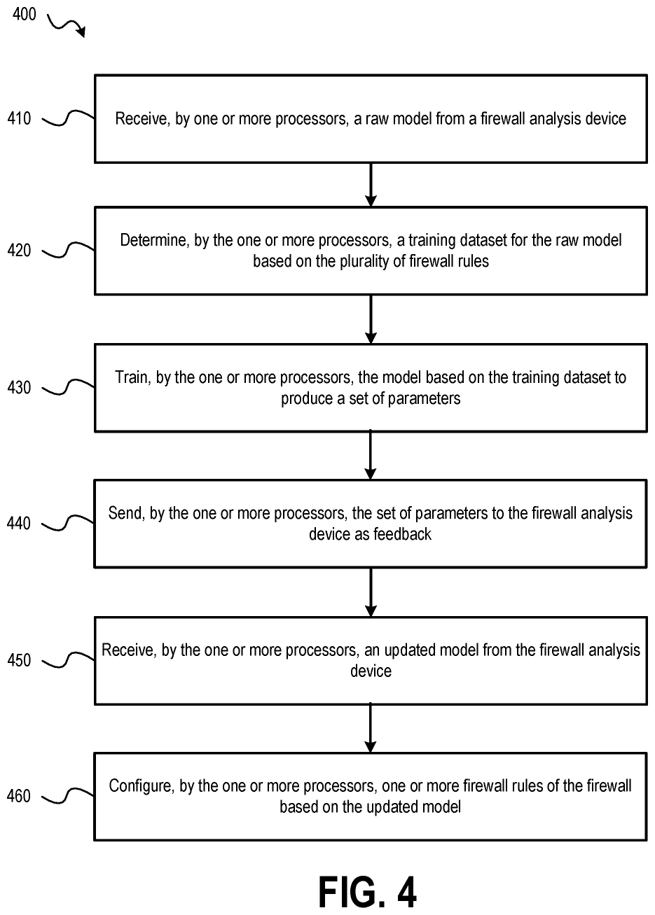

Referring to FIG. 4, a flow diagram of a method for configuring firewall rules in accordance with embodiments of the present disclosure is shown as a method 400. In aspects, the operations of the method 400 may be stored as instructions that, when executed by one or more processors (e.g., the one or more processors of a computing device of an organization), cause the one or more processors to perform the steps of the method 400. In aspects, the method 400 may be performed by a user device, such as a user device 146 of FIG. 1 (e.g., a user device associated with IT personnel).

At step 410, the method 400 includes receiving, by one or more processors, a raw model from a firewall analysis device. In aspects, the raw model may be the raw model 126 of FIGS. 1-3. At step 420, the method 400 includes determining, by the one or more processors, a training dataset for the raw model based on the plurality of firewall rules. As described above with reference to FIG. 1, the training dataset may include firewall rules utilized in the organization's firewall for which there is a high level of confidence the rule is correctly labeled. At step 430, the method 400 includes training, by the one or more processors, the model based on the training dataset to produce a set of parameters. As explained above, training the model may include providing the training dataset of firewall rules (and possibly additional data) as inputs to the raw model, and the model may generate outputs (e.g., labels) based on the input dataset.

At step 440, the method 400 includes sending, by the one or more processors, the set of parameters to the firewall analysis device as feedback. It is noted that while the method 400 describes operations of a single entity, the feedback provided at step 440 may be one of many streams of feedback provided to the firewall analysis device, as described above with reference to FIGS. 2 and 3. At step 450, the method 400 includes receiving, by the one or more processors, an updated model from the firewall analysis device. As described above with reference to FIGS. 1-3, the updated model may include a set of parameters derived based at least in part on the feedback. At step 460, the method 400 includes configuring, by the one or more processors, one or more firewall rules of the firewall based on the updated model. As described above with reference to FIGS. 1-3, the models may enable configuration of new firewall rules, consolidation of firewall rules, and changing of firewall rules based on labels provided by the model.

As shown above, the method 400 facilitates operations that significantly improve the firewall of an organization by allowing that organization to more accurately label firewall rules, establish firewall rules addressing a larger scope within an address space (e.g., an IPv4 or IPv6 address space) than the organization may otherwise be capable of doing, and consolidate or reduce the number of firewall rules for the firewall while maintaining the protections and security of the firewall, which may simply allow the firewall to operate on a reduced number of firewall rules or free up space to add additional firewall rules that would otherwise degrade the performance of the firewall. It is noted that the method 400 may include additional operations described in connection with the various embodiments illustrated and described with reference to FIGS. 1-3 and the organizations illustrated therein.

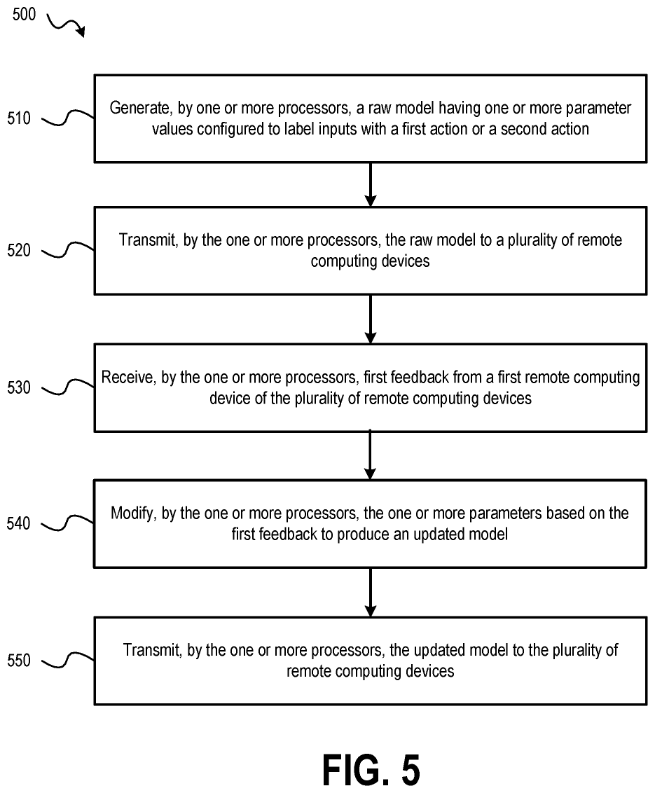

Referring to FIG. 5, a flow diagram of a method for configuring models for labelling and optimizing firewall rules in accordance with embodiments of the present disclosure is shown as a method 500. In aspects, the operations of the method 500 may be stored as instructions (e.g., the instructions 116 of FIG. 1) that, when executed by one or more processors (e.g., the one or more processors 112 of FIG. 1), cause the one or more processors to perform the steps of the method 500. In aspects, the method 500 may be performed by a firewall analysis device (e.g., the firewall analysis device 110 of FIG. 1).

At step 510, the method 500 includes generating, by one or more processors, a raw model having one or more parameter values configured to label inputs with a first action or a second action. As described above with reference to FIGS. 1-3, the first action and the second action correspond to actions to be taken when a particular input is detected by a firewall, such as to apply an allow label or a deny label to a firewall rule received as an input. At step 520, the method 500 includes transmitting, by the one or more processors, the raw model to a plurality of remote computing devices. As described above with reference to FIGS. 1-3, the plurality of remote computing devices include computing devices belonging to different organizations.

At step 530, the method 500 includes receiving, by the one or more processors, first feedback from a first remote computing device of the plurality of remote computing devices, the first remote computing device associated with a first organization of the different organizations. The first feedback may be generated via training of the raw model by the first remote computing device (e.g., the first organization) based on training data associated with a firewall of the first organization. It is noted that additional feedback may be received from other organizations based on localized training of the raw model by each of the other organizations, as described above with reference to FIGS. 2 and 3. At step 540, the method 500 includes modifying, by the one or more processors, the one or more parameters based on the first feedback to produce an updated model. As described above, the training of the model may be based on firewall rules that are known to accurately label connections to IP addresses or domains (e.g., network resources). When the model suggests a label that is inconsistent with the label that is known to be accurate, the feedback may provide an indication that the label is inaccurate and the modification of the parameters of the model may be adjusted to produce a more accurate label output. Overtime, the model may be trained and updated such that the model will correctly output a label that matches the label of the training data, thereby producing accurate labels for firewall rules. This may enable the model to provide firewall rules to different organizations without requiring the organization to actually share their firewall rules with each other. At step 550, the method 500 includes transmitting, by the one or more processors, the updated model to the plurality of remote computing devices. As described above, the updated models may include new parameter values that may more accurately apply labels, with the accuracy of the model-suggested labels improving over time as more training data is provided and more updated models are generated. It is noted that the method 500 may include additional operations described in connection with the firewall analysis devices of embodiments with reference to FIGS. 1-3, such as consolidating firewall rules or other functionality.

As shown above, the method 500 facilitates operations that significantly improve the firewall of an organization by allowing that organization to more accurately label firewall rules using labels provided by models of embodiments. This may enable some organizations to establish firewall rules addressing a larger scope within an address space (e.g., an IPv4 or IPv6 address space) than the organization may otherwise be capable of doing due to the complex nature of configuring firewall rules, and consolidate or reduce the number of firewall rules for the firewall while maintaining the protections and security of the firewall, which may simply allow the firewall to operate with a reduced number of firewall rules or free up space to add additional firewall rules that would otherwise degrade the performance of the firewall.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The functional blocks and modules described herein (e.g., the functional blocks and modules in FIGS. 1-5) may comprise processors, electronics devices, hardware devices, electronics components, logical circuits, memories, software codes, firmware codes, etc., or any combination thereof. In addition, features discussed herein relating to FIGS. 1-5 may be implemented via specialized processor circuitry, via executable instructions, and/or combinations thereof.

As used herein, various terminology is for the purpose of describing particular implementations only and is not intended to be limiting of implementations. For example, as used herein, an ordinal term (e.g., “first,” “second,” “third,” etc.) used to modify an element, such as a structure, a component, an operation, etc., does not by itself indicate any priority or order of the element with respect to another element, but rather merely distinguishes the element from another element having a same name (but for use of the ordinal term). The term “coupled” is defined as connected, although not necessarily directly, and not necessarily mechanically; two items that are “coupled” may be unitary with each other. The terms “a” and “an” are defined as one or more unless this disclosure explicitly requires otherwise. The term “substantially” is defined as largely but not necessarily wholly what is specified—and includes what is specified; e.g., substantially 90 degrees includes 90 degrees and substantially parallel includes parallel—as understood by a person of ordinary skill in the art. In any disclosed embodiment, the term “substantially” may be substituted with “within [a percentage] of” what is specified, where the percentage includes 0.1, 1, 5, and 10 percent; and the term “approximately” may be substituted with “within 10 percent of” what is specified. The phrase “and/or” means and or. To illustrate, A, B, and/or C includes: A alone, B alone, C alone, a combination of A and B, a combination of A and C, a combination of B and C, or a combination of A, B, and C. In other words, “and/or” operates as an inclusive or. Additionally, the phrase “A, B, C, or a combination thereof” or “A, B, C, or any combination thereof” includes: A alone, B alone, C alone, a combination of A and B, a combination of A and C, a combination of B and C, or a combination of A, B, and C.

The terms “comprise” and any form thereof such as “comprises” and “comprising,” “have” and any form thereof such as “has” and “having,” and “include” and any form thereof such as “includes” and “including” are open-ended linking verbs. As a result, an apparatus that “comprises,” “has,” or “includes” one or more elements possesses those one or more elements, but is not limited to possessing only those elements. Likewise, a method that “comprises,” “has,” or “includes” one or more steps possesses those one or more steps, but is not limited to possessing only those one or more steps.

Any implementation of any of the apparatuses, systems, and methods can consist of or consist essentially of—rather than comprise/include/have—any of the described steps, elements, and/or features. Thus, in any of the claims, the term “consisting of” or “consisting essentially of” can be substituted for any of the open-ended linking verbs recited above, in order to change the scope of a given claim from what it would otherwise be using the open-ended linking verb. Additionally, it will be understood that the term “wherein” may be used interchangeably with “where.”

Further, a device or system that is configured in a certain way is configured in at least that way, but it can also be configured in other ways than those specifically described. Aspects of one example may be applied to other examples, even though not described or illustrated, unless expressly prohibited by this disclosure or the nature of a particular example.

Those of skill would further appreciate that the various illustrative logical blocks, modules, circuits, and algorithm steps (e.g., the logical blocks in FIGS. 6-7) described in connection with the disclosure herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure. Skilled artisans will also readily recognize that the order or combination of components, methods, or interactions that are described herein are merely examples and that the components, methods, or interactions of the various aspects of the present disclosure may be combined or performed in ways other than those illustrated and described herein.

The various illustrative logical blocks, modules, and circuits described in connection with the disclosure herein may be implemented or performed with a general-purpose processor, a digital signal processor (DSP), an ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the disclosure herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

In one or more exemplary designs, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. Computer-readable storage media may be any available media that can be accessed by a general purpose or special purpose computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code means in the form of instructions or data structures and that can be accessed by a general-purpose or special-purpose computer, or a general-purpose or special-purpose processor. Also, a connection may be properly termed a computer-readable medium. For example, if the software is transmitted from a website, server, or other remote source using a coaxial cable, fiber optic cable, twisted pair, or digital subscriber line (DSL), then the coaxial cable, fiber optic cable, twisted pair, or DSL, are included in the definition of medium. Disk and disc, as used herein, includes compact disc (CD), laser disc, optical disc, digital versatile disc (DVD), hard disk, solid state disk, and blu-ray disc where disks usually reproduce data magnetically, while discs reproduce data optically with lasers. Combinations of the above should also be included within the scope of computer-readable media.

The above specification and examples provide a complete description of the structure and use of illustrative implementations. Although certain examples have been described above with a certain degree of particularity, or with reference to one or more individual examples, those skilled in the art could make numerous alterations to the disclosed implementations without departing from the scope of this invention. As such, the various illustrative implementations of the methods and systems are not intended to be limited to the particular forms disclosed. Rather, they include all modifications and alternatives falling within the scope of the claims, and examples other than the one shown may include some or all of the features of the depicted example. For example, elements may be omitted or combined as a unitary structure, and/or connections may be substituted. Further, where appropriate, aspects of any of the examples described above may be combined with aspects of any of the other examples described to form further examples having comparable or different properties and/or functions, and addressing the same or different problems. Similarly, it will be understood that the benefits and advantages described above may relate to one embodiment or may relate to several implementations.

The claims are not intended to include, and should not be interpreted to include, means plus- or step-plus-function limitations, unless such a limitation is explicitly recited in a given claim using the phrase(s) “means for” or “step for,” respectively.

Although the aspects of the present disclosure and their advantages have been described in detail, it should be understood that various changes, substitutions and alterations can be made herein without departing from the spirit of the disclosure as defined by the appended claims. Moreover, the scope of the present application is not intended to be limited to the particular implementations of the process, machine, manufacture, composition of matter, means, methods and steps described in the specification. As one of ordinary skill in the art will readily appreciate from the present disclosure, processes, machines, manufacture, compositions of matter, means, methods, or steps, presently existing or later to be developed that perform substantially the same function or achieve substantially the same result as the corresponding embodiments described herein may be utilized according to the present disclosure. Accordingly, the appended claims are intended to include within their scope such processes, machines, manufacture, compositions of matter, means, methods, or steps.

What is claimed is:

1. A method for generating models configured to label firewall rules, the method comprising:
generating, by one or more processors, a raw model having one or more parameter values configured to label inputs with a first action or a second action, the first action and the second action corresponding to actions to be taken when a particular input is detected by a firewall;
transmitting, by the one or more processors, the raw model to a plurality of remote computing devices, the plurality of remote computing devices including computing devices belonging to different organizations;
receiving, by the one or more processors, first feedback from a first remote computing device of the plurality of remote computing devices, the first remote computing device associated with a first organization of the different organizations, wherein the first feedback is generated via training of the raw model by the first remote computing device based on a training data associated with a firewall of the first organization;
modifying, by the one or more processors, the one or more parameters based on the first feedback to product an updated model; and
transmitting, by the one or more processors, the updated model to the plurality of remote computing devices.

2. The method of claim 1, further comprising:
receiving, by the one or more processors, second feedback from a second remote computing device of the plurality of remote computing devices, the second remote computing device associated with a second organization of the different organizations, wherein the second feedback is generated via training of the raw model by the second remote computing device training data associated with a firewall of the second organization; and
modifying, by the one or more processors, the one or more parameters based on the second feedback to product the updated model.

3. The method of claim 2, further comprising:
aggregating the first feedback and the second feedback; and
calculating modified parameter values based on the aggregating, wherein the one or more parameter values are modified based on the aggregating of the first feedback and the second feedback.

4. The method of claim 2, further comprising applying weights to the first feedback and the second feedback, wherein the one or more parameter values are modified based on the weights applied to the first feedback and the second feedback.

5. The method of claim 1, wherein the inputs to the model comprise one or more firewall rules of a firewall of the first organization, the one or more firewall rules associated with connections to one or more network resources, and wherein the first action and the second action correspond to labels applied to the firewall rules received as inputs to the model.

6. The method of claim 5, wherein the first action is an allow action configured to allow a connection to one or more network resources associated with a particular firewall rule.

7. The method of claim 5, wherein the second action is a deny action configured to prevent a connection to one or more network resources associated with a particular firewall rule.

8. The method of claim 5, wherein the first feedback does not include the one or more firewall rules.

9. The method of claim 1, wherein the model comprises a plurality of scores, each score indicating a confidence level associated with a label applied to an input by the model.

10. The method of claim 1, wherein the inputs to the model comprise one or more data sources selected from the list consisting of: live network traffic flows, web traffic proxy logs, netflow data, application logs, e-commerce logging data, distributed denial of service (DDoS) attack data, anti-virus alerts, security incident tickets, or snort alerts or logs.

11. The method of claim 1, further comprising receiving a dataset comprising features of an address space, wherein the model is generated based, at least in part, on the dataset.

12. A non-transitory computer-readable storage medium storing instructions that, when executed by one or more processors, cause the one or more processors to perform operations for generating models configured to label firewall rules, the method comprising:
generating a raw model having one or more parameter values configured to label inputs with a first action or a second action, the first action and the second action corresponding to actions to be taken when a particular input is detected by a firewall;
transmitting the raw model to a plurality of remote computing devices, the plurality of remote computing devices including computing devices belonging to different organizations;
receiving first feedback from a first remote computing device of the plurality of remote computing devices, the first remote computing device associated with a first organization of the different organizations, wherein the first feedback is generated via training of the raw model by the first remote computing device based on a training data associated with a firewall of the first organization, and wherein the first feedback does not include firewall rules of the first organization;
modifying the one or more parameters based on the first feedback to product an updated model; and
transmitting the updated model to the plurality of remote computing devices.

13. The non-transitory computer-readable storage medium of claim 12, further comprising:
receiving additional feedback from additional remote computing devices of the plurality of remote computing devices, the additional remote computing devices associated with additional organizations of the different organizations, wherein the additional feedback received from each additional organization is generated via training of the raw model based on training data specific to each additional organization; and
modifying the one or more parameters based on the additional feedback to product the updated model.

14. The non-transitory computer-readable storage medium of claim 13, further comprising:
aggregating the first feedback and the additional feedback; and
calculating modified parameter values based on the aggregating, wherein the one or more parameter values are modified based on the aggregating of the first feedback and the second feedback.

15. The non-transitory computer-readable storage medium of claim 13, further comprising applying weights to the first feedback and the additional feedback, wherein the one or more parameter values are modified based on the weights applied to the first feedback and the additional feedback.

16. The non-transitory computer-readable storage medium of claim 12, wherein the inputs to the model comprise one or more firewall rules of a firewall of the first organization, the one or more firewall rules associated with connections to one or more network resources, and wherein the first action and the second action correspond to labels applied to the firewall rules received as inputs to the model, the first action corresponding to an allow action configured to allow a connection to one or more network resources associated with a particular firewall rule and the second action corresponding to a deny action configured to prevent a connection to one or more network resources associated with a particular firewall rule.

17. A system comprising:
a firewall comprising a plurality of firewall rules;
a memory; and
one or more processors communicatively coupled to the memory and the firewall, the one or more processors configured to:
receive a raw model from a firewall analysis device;
determine a training dataset for the raw model based on the plurality of firewall rules;
train the model based on the training dataset to produce a set of parameters;
send the set of parameters to the firewall analysis device as feedback;
receive an updated model from the firewall analysis device, the updated model comprising a set of parameters derived based at least in part on the feedback; and
configure one or more firewall rules of the firewall based on the updated model.

18. The system of claim 17, wherein determining the training dataset comprises selecting one or more firewall rules from among the firewall rules, each of the one or more firewall rules selected for inclusion in the training dataset associated with a score satisfying a threshold confidence level.

19. The system of claim 17, wherein the one or more processors are configured to test the one or more firewall rules configured based on the updated model prior to adding the one or more firewall rules to the firewall.

20. The system of claim 17, wherein configuring the one or more firewall rules comprises modifying one or more labels of the firewall rules based on the updated model.
